(19) United States
(12) Patent Application Publication
(10) Pub. No.: US 2025/0212154 A1
(43) Pub. Date: Jun. 26, 2025

(54) AREA DETERMINATION SYSTEM, AREA DETERMINATION METHOD, AND PROGRAM

(71) Applicant: Panasonic Intellectual Property Management Co., Ltd., Osaka (JP)

(72) Inventors: Yanfeng WANG, Osaka (JP); Takatomo OTSUKA, Osaka (JP); Kazuhiro TANIGUCHI, Chiba (JP); Kenichi SASAI, Osaka (JP); Yosuke UKITA, Osaka (JP); Tomoki TAKAZOE, Kanagawa (JP)

(21) Appl. No.: 18/832,357

(22) PCT Filed: Dec. 26, 2022
(86) PCT No.: PCT/JP2022/047905

§ 371 Date: Jan. 3, 2025

(30) Foreign Application Priority Data
Jan. 27, 2022 (JP) 2022-011289

(51) Int. Cl. H04W 64/00; G01S 11/06; H04J 3/06

(52) U.S. Cl. CPC H04W 64/00; G01S 11/06; H04J 3/0661

(57) ABSTRACT

The problem is to improve the accuracy of decision about the presence or absence of mobile device in/from a target area. A detection unit detects, based on a received signal strength of a wireless signal (W10) being transmitted and received to/from a mobile device (40), location of the mobile device (40) to acquire mobile device location information. A first determination unit determines, based on the mobile device location information, whether the mobile device (40) is present in a target area. An obtaining unit obtains a number of times (n) of decisions of presence, which indicates the number of times that the first determination unit has decided that the mobile device (40) be present in the target area during a target period having a predetermined length (T). A second determination unit decides, when the number of times (n) of decisions of presence is equal to or greater than a predetermined number of times (N), that the mobile device (40) be present in the target area during the target period and decides, when the number of times (n) of decisions of presence is less than the predetermined number of times (N), that the mobile device (40) be absent from the target area during the target period. A control unit controls, using at least one selected from a time lag between multiple decisions of presence during the target period, the predetermined length (T), and the predetermined number of times (N), either determination processing by the second determination unit or decisions made by the second determination unit.

### TECHNICAL FIELD

The present disclosure generally relates to an area determination system, an area determination method, and a program. More particularly, the present disclosure relates to an area determination system, an area determination method, and a program, all of which are used to determine whether a mobile device is present in a target area or not.

### BACKGROUND ART

Patent Literature 1 discloses a technique for determining, based on, for example, a threshold value for the number of times of reception within a given area or a non-reception interval, whether a transmitter such as a beacon tag is located in the vicinity of a receiver. For example, this technique may be used to determine whether a beacon tag carried by a child is present in, or absent from, a school where the receiver is installed.

In recent years, an open space such as an open meeting room has been used more and more often. In such an open space, no walls are often provided at a boundary between multiple areas to make it easier to move across the boundary between the multiple areas such as intruding into an adjacent area or entering and leaving a room by passing through other areas. That is why applying the technique of Patent Literature 1 to such an open space may cause a decline in the accuracy of determining whether a mobile device such as a beacon tag is present in, or absent from, a target area.

### CITATION LIST

### Patent Literature

Patent Literature 1: JP 2018-180972 A

### SUMMARY OF INVENTION

An object of the present disclosure is to provide an area determination system, an area determination method, and a program, all of which contributing to improving the accuracy of determining whether a mobile device is present in, or absent from, a target area.

An area determination system according to an aspect of the present disclosure includes a detection unit, a first determination unit, an obtaining unit, a second determination unit, and a control unit. The detection unit detects, based on a received signal strength of a wireless signal being transmitted and received to/from a mobile device, location of the mobile device to acquire mobile device location information indicating a result of detection. The first determination unit determines, based on the mobile device location information, whether the mobile device is present in a target area. The obtaining unit obtains a number of times of decisions of presence. The number of times of decisions of presence indicates a numerical number of times that the first determination unit has decided that the mobile device be present in the target area during a target period having a predetermined length. The second determination unit decides, when the number of times of decisions of presence is equal to or greater than a predetermined number of times, that the mobile device be present in the target area during the target period and decides, when the number of times of decisions of presence is less than the predetermined number of times, that the mobile device be absent from the target area during the target period. The control unit controls, using at least one selected from the group consisting of a time lag between multiple decisions of presence during the target period, the predetermined length, and the predetermined number of times, either determination processing by the second determination unit or decisions made by the second determination unit.

An area determination method according to another aspect of the present disclosure includes a detection step, a first determination step, an obtaining step. a second determination step, and a control step. The detection step includes detecting, based on a received signal strength of a wireless signal being transmitted and received to/from a mobile device, location of the mobile device to acquire mobile device location information indicating a result of detection. The first determination step includes determining, based on the mobile device location information, whether the mobile device is present in a target area. The obtaining step includes obtaining a number of times of decisions of pre ice. The number of times of decisions of presence indicates a numerical number of times that a decision has been made in the first determination step that the mobile device be present in the target area during a target period having a predetermined length. The second determination step includes deciding, when the number of times of decisions of presence is equal to or greater than a predetermined number of times, that the mobile device be present in the target area during the target period and deciding, when the number of times of decisions of presence is less than the predetermined number of times, that the mobile device be absent from the target area during the target period. The control step includes controlling, using at least one selected from the group consisting of a time lag between multiple decisions of presence during the target period, the predetermined length, and the predetermined number of times, either determination processing in the second determination step or decisions made in the second determination step.

A program according to still another aspect of the present disclosure is designed to cause one or more processors to perform the area determination method described above.

### BRIEF DESCRIPTION OF DRAWINGS

FIG. 1 is a block diagram of an area determination system according to an exemplary embodiment of the present disclosure;

FIG. 2 is a block diagram of a server included in the area determination system according to the exemplary embodiment;

FIG. 3 is a top view of a target area for the area determination system according to the exemplary embodiment;

FIG. 4 is a flowchart showing the procedure of some processing steps (location detection and first determination) to be performed by the server according to the exemplary embodiment;

FIG. 5 is a flowchart showing the procedure of other processing steps (second determination and control according to a first method) to be performed by the server according to the exemplary embodiment;

FIG. 6 is a flowchart showing the procedure of the location detection according to the exemplary embodiment;

FIG. 7A is a timing chart showing an exemplary result of control by the first method according to the exemplary embodiment;

FIG. 7B is a timing chart showing another exemplary result of control by the first method according to the exemplary embodiment;

FIG. 8 is a flowchart showing the procedure of control (by a second method) according to a first variation of the exemplary embodiment;

FIG. 9A is a timing chart showing an exemplary result of second determination (in a situation where the control by the second method is not performed) to be compared with the result of control according to the second method of the exemplary embodiment;

FIG. 9B is a timing chart showing an exemplary result of control according to the second method of the exemplary embodiment;

FIG. 10 is a flowchart showing the procedure of control (by a third method) according to a second variation of the exemplary embodiment;

FIG. 11A is a timing chart showing an exemplary result of control by the third method according to the exemplary embodiment; and

FIG. 11B is a timing chart showing another exemplary result of control by the third method according to the exemplary embodiment.

### DESCRIPTION OF EMBODIMENTS

Note that the exemplary embodiment to be described below is only an exemplary one of various embodiments of the present disclosure and should not be construed as limiting, Rather, the exemplary embodiment may be readily modified in various manners depending on a design choice or any other factor without departing from the scope of the present disclosure.

### (1) Principal Feature

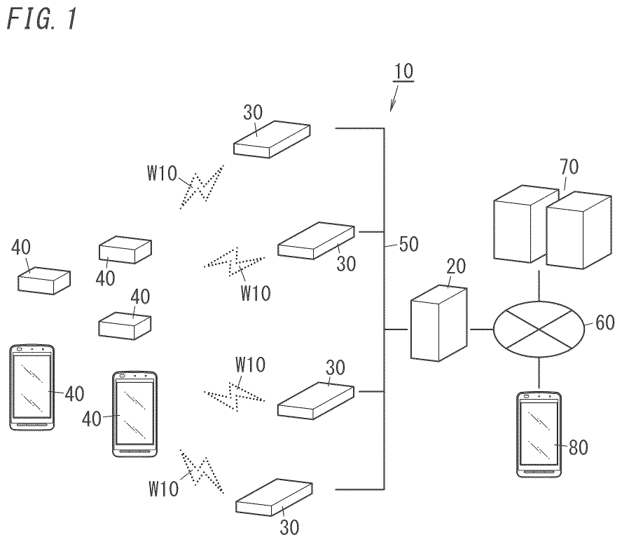

First, a principal feature of an area determination system 10 according to an exemplary embodiment of the present disclosure will be described with reference to FIGS. 1-3. The area determination system 10 includes a server 20. The server 20 includes a detection unit 221, a first determination unit 222, an obtaining unit 223, a second determination unit 224, and a control unit 225.

### (1-1) Location Detection

The detection unit 221 detects the location of a mobile device 40 based on the received signal strength of a wireless signal W10 being transmitted and received to/from the mobile device 40 to acquire mobile device location information indicating a result of detection.

As used herein, the “mobile device 40” refers to, for example, one of the five mobile devices 40 shown in FIG. 1. The mobile device 40 transmits and receives a wireless signal W10 to/from each of the four terminals 30 (hereinafter simply referred to as “terminals 30”) shown in FIG. 1.

Note that although it will be described in detail later, the mobile device 40 includes a transmitter and the terminals 30 each include a receiver in this embodiment. The detection unit 221 according to this embodiment detects, via any one of the terminals 30 each having the receiver. the location of the mobile device 40 based on the received signal strength of the wireless signal W10 at the receiver. However, this is only an example and should not be construed as limiting. Alternatively, the terminals 30 may each include a transmitter and the mobile device 40 may include a receiver. Still alternatively, the server 20, for example, may include a receiver. This allows the location of the mobile device 40 to be detected not via any of the terminals 30.

### (1-1-1) Wireless Signal

The wireless signal W10 is transmitted from the transmitter (not shown) of one member selected from the group consisting of one of the terminals 30 and the mobile device 40 (e.g., from the mobile device 40) and received by the receiver (not shown) of the other member selected from the group consisting of the terminal 30 and the mobile device 40 (e.g., by the terminal 30). The wireless signal W10 is ordinarily a signal compliant with a short-range wireless communications protocol, which may be, for example, the Bluetooth (R) protocol.

### (1-1-2) Location Detection Based on Received Signal Strength

The received signal strength may be, for example, the received signal strength indicator (RSSI) and the location detection may be made by, for example, positioning based on the RSSI. In this embodiment, the location of each terminal 30 is known and terminal location information indicating the location of the terminal 30 is stored in advance in a memory.

The detection unit 221 acquires, based on, for example, the RSSI value and the terminal location information, mobile device location information indicating the location of the mobile device 40. For example, the three-dimensional coordinates of the mobile device 40 may be obtained based on, for example, three or more pieces of terminal location information about three or more terminals 30 and three or more radio wave strengths corresponding to the three or more terminals 30.

The detection unit 221 according to this embodiment obtains the two-dimensional coordinates of the mobile device 40 based on, for example, four pieces of terminal location information about the four terminals 30 and four radio wave strengths corresponding to the four terminals 30.

Note that the mobile device location information thus acquired is normally accumulated in a memory but may be retained only temporarily without being accumulated there.

### (1-2) First Determination: Presence/Absence Determination Based on Mobile Device Location Information

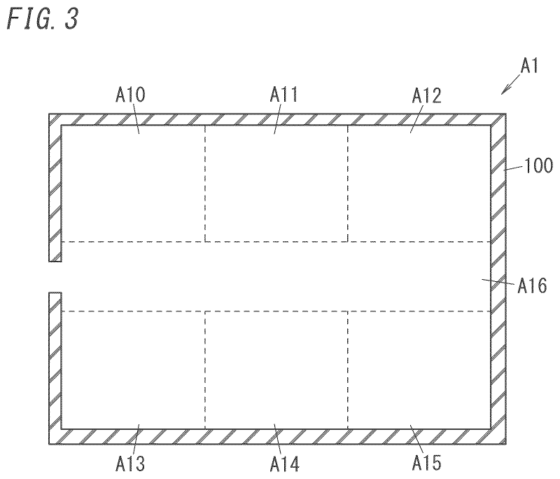

The first determination unit 222 determines, based on the mobile device location information acquired by the detection unit 221, whether the mobile device 40 is present in, or absent from, a target area (e.g., the area A10 shown in FIG. 3 (hereinafter referred to as a “target area A10”)) (i.e., makes presence/absence determination).

More specifically, area location information indicating the location of the target area A10 is stored in advance in a memory. The first determination unit 222 determines, based on the mobile device location information acquired by the detection unit 221 and the area location information stored in the memory, whether the mobile device 40 is present in, or absent from, the target area A10.

### (1-3) Accumulation of Presence Information/Absence Information

The first determination unit 222 makes the first determination as described above to acquire either presence information or absence information. As used herein, the “presence information” refers to a piece of information indicating a decision of presence (i.e., that a decision of presence bas been made). In this embodiment, the presence information may be, for example, a flag “1.” As used herein, the “absence information” refers to a piece of information indicating a decision of absence (Le., that a decision of absence has been made), In this embodiment, the absence information may be, for example, a flag “0.”

The first determination unit 222 accumulates either the presence information or the absence information in the memory in association with, for example, a set consisting of timestamp information, a mobile device identifier, and an area identifier. Note that the presence/absence information may be retained only temporarily,

As used herein, the “mobile device identifier” refers to a piece of information for use to identify the mobile device 40. The mobile device identifier may be, for example, a media access control (MAC) address or an ID. As used herein, the “area identifier” refers to a piece of information for use to identify a given area. The area identifier may be, for example, the name of the area (such as the name of a meeting room or the number of the room) or an ID (such as a serial number, a character, or a sequence of signs) associated with the name of the area.

Accumulating either the presence information or the absence information in association with the timestamp information in this manner allows the number of times of decisions of presence to be obtained a posteriori by counting, by reference to the storage (i.e., the memory), the number of pieces of timestamp information belonging to a predetermined period which are associated with the presence information. In addition, this also makes it easier to calculate the time lag (e.g., the maximum difference Δt) between multiple decisions of presence. Furthermore, this further makes it easier to perform control using at least one selected from the group consisting of the time lag, a predetermined length T, and a predetermined number of times N.

### (1-4) Obtaining Number of Times of Decisions of Presence

The obtaining unit 223 obtains the number of times n of decisions of presence. As used herein, the “number of times n of decisions of presence” refers to the number of times that the decision of presence has been made, i.e., the number of times that the first determination unit 222 has decided that the mobile device 40 be present in the target area A10, during a target period having the predetermined length T.

The obtaining unit 223 according to this embodiment may count the number of times n of decisions of presence in real time by, for example, making increment to a variable “n” indicating the number of times of decisions of presence every time the first determination unit 222 makes the decision of presence. Alternatively, the number of times n of decisions of presence may also be obtained a posteriori by, for example, counting the number of pieces of presence information stored in the memory.

### (1-4-1) Predetermined Length

As used herein, the “predetermined length T” refers to a parameter indicating the time length of the target period. In this embodiment, the predetermined length T is normally a fixed value and may be 180 seconds, for example. Nevertheless, the predetermined length T may be changed by the control unit 225 (refer to the description of a second variation to be described later).

### (1-4-2) Target Period

As used herein, the “target period” refers to a period in which the number of times n of decisions of presence is to be obtained. The target period is determined by period information. As used herein, the “period information” refers to a piece of information about a given period. The period information may include, for example, a set consisting of a start time ts and an end time te.

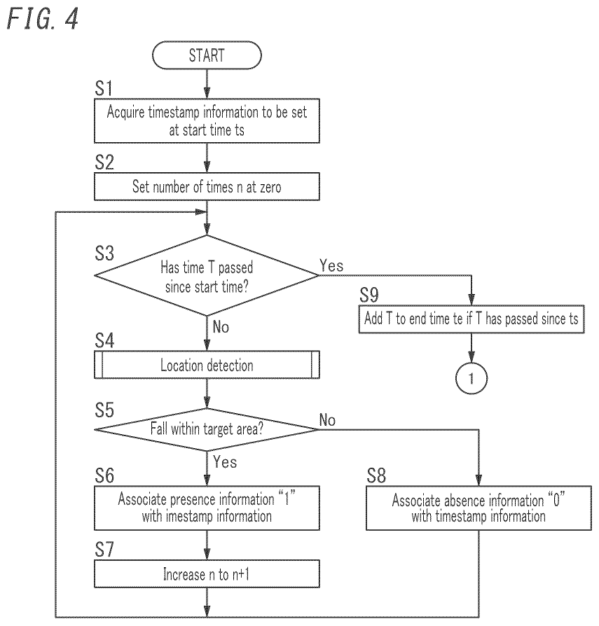

As used herein, the “start time ts” refers to a timestamp indicating the beginning of the target period. The start time ts may be obtained from, for example, a clock built in a processor or a network time protocol (NTP) server (not shown) in response to the startup of the area determination system 10 (i.e., as soon as the area determination processing shown in FIG. 4 is started).

As used herein, the “end time te” refers to a timestamp indicating the end of the target period. The end time te may be calculated by adding the predetermined length T to the start time te (i.e., te=ts+T). Nevertheless, at least one of the start time ts or the end time te may be changed by the control unit 225 (refer to the description of the second variation to be described later).

The period information normally further includes a period identifier. As used herein, the “period identifier” refers to a piece of information for use to identify a given period. The period identifier may be, for example, a serial number such as “1” or “2” but may also be an ID as a combination of characters and signs. Note that in this embodiment, a reference sign such as “P1,” “P2,” or “P3” is used as the period identifier for the sake of convenience.

Optionally, two adjacent target periods (i.e., the target period and the next target period) may partially overlap with each other. That is to say, the end of the target period may be located between the beginning and end of the next target period.

### (1-5) Second Determination: Presence/Absence Determination Based on Number of Times of Decisions of Presence

The second determination unit 224 determines, based on the number of times n of decisions of presence obtained by the obtaining unit 223, whether the mobile device 40 is present in, or absent from, the target area A10 in the target period.

### (1-5-1) Decision of Presence

The second determination unit 224 decides, if the number of times n of decisions of presence is equal to or greater than a predetermined number of times N. for example, that the mobile device 40 be present in the target area A10 during the target period. In response to such a decision of presence, the second determination unit 224 may associate, for example, the presence information (e.g., the flag “1”) with the period information (e.g., the set consisting of the mobile device identifier, the area identifier, and the period information in this embodiment),

### (1-5-2) Decision of Absence

On the other hand, the second determination unit 224 decides, if the number of times n of decisions of presence is less than the predetermined number of times N, for example, that the mobile device 40 be absent from the target area A10 during the target period. In response to such a decision of absence, the second determination unit 224 may associate, for example, the absence information (e.g., the flag “0”) with the period information (e.g., the set consisting of the mobile device identifier, the area identifier, and the period information in this embodiment).

### (1-5-3) Predetermined Number of Times

The predetermined number of times N is a parameter for use as a threshold value of a decision to be made by the second determination unit 224. The value of the predetermined number of times N is a predetermined integer equal to or greater than 2 and is normally a fixed value (of 3, for example) (according to the first method and the second method, as for the latter, refer to the description of a first variation to be described later). Nevertheless, the value of the predetermined number of times N may be changed by the control unit 225 (according to the third method, refer to the description of the second variation to be described later).

The second determination unit 224 passes the set consisting of the period information and other pieces of information and the presence information, or the set consisting of the period information and other pieces of information and the absence information of these two sets which have been obtained in this manner, to an output unit 23 (to be described later).

### (1-6) Control of Determination Processing or Processing Result of Second Determination

The control unit 225 controls the determination processing performed by the second determination unit 224 or the decision made by the second determination unit 224 by using at least one parameter selected from the group consisting of the time lag between multiple decisions of presence in the target period (i.e., the maximum difference Δt to be described later), the predetermined length T, and the predetermined number of times N.

The control unit 225 may control either the determination processing performed by the second determination unit 224 or the decision made by the second determination unit 224 by, for example, the following three methods:

### (1-6-1) First Method: Use of Maximum Difference

According to the first method, the determination processing by the second determination unit 224 is controlled by using the maximum difference Δt between multiple timestamps corresponding to multiple decisions of presence made by the first determination unit 222. Specifically, even if the number of times n of decisions of presence is equal to or greater than the predetermined number of times N but the maximum difference Δt is greater than the threshold value Δt0, the second determination unit 224 is made to make a decision of absence.

### (1-6-2) Second Method: Control of Period Length T Based on Decision Made by Second Determination Unit 224 and Decision Made Right After That by First Determination Unit 222

According to the second method, the target period is extended (i.e., the period length T is increased) by postponing the end of the target period when a decision, similar to the decision made by the second determination unit 224 during the target period, is made by the first determination unit 222 within the predetermined time ΔT from the end of the target period. Note that if the end of the target period is postponed, then the beginning (boundary) of the next target period is also postponed. Alternatively, the beginning of the next target period does not have to be postponed. That is to say, the current target period and the next target period may partially overlap with each other.

### (1-6-3) Third Method: Change of Predetermined Length T, for Example, of Next Target Period in Accordance With Decision Made by Second Determination Unit in Target Period

According to the third method, at least one of the predetermined length T or the predetermined number of times N in the next target period is changed in accordance with the decision (or the number of times n of decisions of presence) made by the second determination unit. 224 during the target period. For example, in a period following an absence period, T is shortened and/or Nis increased. In a period following a presence period. T is extended and/or N is decreased.

Note that the control unit 225 according to this embodiment normally adopts the first method. Alternatively, the control unit 225 may also adopt the second method (refer to the description of the first variation to be described later) or the third method (refer to the description of the second variation to be described later). Still alternatively, each of the second and third methods may be adopted in combination with the first method. Yet alternatively, any one of the first, second, and third methods may be adopted selectively. That is to say, an acceptance unit 21 (to be described later) accepts the operation of selecting any one of the first, second, and third methods, or the combination of the first and second methods, or the combination of the first and third methods, and the control unit 225 may adopt either the selected method or the selected combination of methods.

In this manner, the area determination system 10 according to this embodiment makes the first determination (presence/absence determination) either at regular intervals or at irregular intervals to determine whether the mobile device 40 is present in, or absent from, the target area (such as the target area A10). Then, the area determination system 10 makes, by comparing the number of times n of decisions of presence during the target period having the predetermined length T with the predetermined number of times N. the second determination to determine whether the target period is a presence period or an absence period. Then, when making the second determination, the area determination system 10 controls either the second determination or the decision of the second determination by using at least one selected from the group consisting of the time lag between the decisions of presence (e.g., the maximum difference Δt), the predetermined length T, and the predetermined number of times N. This contributes to more accurately determining whether the mobile device 40 is present in, or absent from, the target area (such as the area A10).

### (2) Details

Next, the area determination system 10 will be described in detail. The area determination system 10 includes, for example, the server 20, three or more (e.g., four in this embodiment) terminals 30, and one or more (e.g., five in this embodiment) mobile devices 40 as shown in FIG. 1. The terminals 30 are stationed either in the target area (such as the area A10) or in the vicinity of the target area. The mobile device 40 may be present either in the target area (such as the area A10) or in the vicinity of the target area.

### (2-1) Target Area

The target area may be, for example, one (e.g., the area A10) of the seven areas A10-A16 shown in FIG. 3 (to be described later). As used herein, the “vicinity of the target area” refers to a space A1 including the seven areas A10-A16, for example.

### (2-2) Space

The four terminals 30 may be, for example, stationed in the space A1 surrounded with walls 100 as shown in FIG. 3. The space A1 may be, for example, the inside of a room in a building. The four terminals 30 may be, for example, distributed on the ceiling (not shown) of the room.

The space A1 shown in FIG. 3 is sectioned into the seven areas A10-A16. Of these seven areas A10-A16, six areas A10-A15 are respective meeting rooms, and the area A16 is a hallway.

In the space A1 shown in FIG. 3, no walls are normally provided on the boundaries between the areas as indicated by the dotted lines. Alternatively, movable divisions such as partitions or openable and closable curtains, for example, may also be provided on at least some of the boundaries between the areas.

### (2-3) Communication Connection

The server 20 is connected to the three or more terminals 30 via a first network 50 to be ready to communicate with each of the three or more terminals 30. The first network 50 is a narrow area network such as a local area network (LAN) or a power line communication (PLC) network.

The terminal 30 may be connected to each of one or more mobile devices 40 (hereinafter simply referred to as “mobile devices 40”) in compliance with a short-range wireless communications protocol. In this example, the short-range wireless communications protocol may be, for example, the Bluetooth (R) protocol, in particular, the Bluetooth (R) Low Energy (BLE) protocol.

In addition, the server 20 may also be connected to a service provider system 70 via a second network 60. The second network 60 is a wide area network such as the Internet or a communications network.

The service provider system 70 may be connected to a terminal device 80 via the second network 60 to be ready to communicate with the terminal device 80.

### (2-4) Wireless Signal and Its Transmitter and Receiver

The wireless signal W10 according to this embodiment may be, for example, a signal compliant with the BLE protocol. The mobile device 40 includes one device selected from the group consisting of a transmitter that transmits the wireless signal W10 and a receiver that receives the wireless signal W10 (neither is shown). The terminal 30 includes the other device selected from the group consisting of the transmitter and the receiver.

In this embodiment, the mobile device 40 includes the transmitter and the terminal 30 includes the receiver. That is to say, he receiver of the terminal 30 receives the wireless signal W10 transmitted from the transmitter of the mobile device 40. The transmitter of the mobile device 40 transmits, for example, a wireless signal W10 with the mobile device identifier of the mobile device 40.

Alternatively, the terminal 30 may include the transmitter and the mobile device 40 may include the receiver. That is to say, the receiver of the mobile device 40 may receive the wireless signal W10 transmitted from the transmitter of the terminal 30. In that case, the transmitter of the terminal 30 transmits, for example, a wireless signal W10 with the terminal identifier of the terminal 30.

The transmitter transmits the wireless signal W10 either at regular intervals or at irregular intervals.

The transmitter according to this embodiment transmits the wireless signal W10 at regular intervals. The transmission interval (transmission cycle) of the wireless signal W10 may be, for example, 1 second. Alternatively, the transmission interval may also be 10 seconds, 1 minute, or any other suitable interval. Optionally, the transmitter may also transmit the wireless signal W10 at irregular intervals (e.g., in response to a request from the terminal 30).

The receiver receives the wireless signal W10 transmitted by the transmitter. Optionally, the receiver may receive, for example, only a part of the wireless signal W10 transmitted by the transmitter at regular intervals. Specifically, if the transmitter transmits the wireless signal W10 at an interval of 1 second, then the receiver may receive the wireless signal W10 at an interval of 10 seconds, for example.

### (2-5) Terminal

The terminal 30 according to this embodiment receives the wireless signal W10 at its receiver to detect the received signal strength and acquire received signal strength information.

As used herein, the “received signal strength information” refers to information about the received signal strength. The received signal strength information includes a numerical value indicating the received signal strength. The received signal strength information according to this embodiment further includes, for example, the terminal identifier of the mobile device 40 that has transmitted the wireless signal W10 and the terminal identifier of the terminal 30 that has received the wireless signal W10.

The terminal 30 receives one or more (e.g., five in this example) wireless signals W10 respectively corresponding to one or more (e.g., five in this example) mobile devices 40 to acquire one or more (e.g., five in this example) pieces of received signal strength information respectively corresponding to the one or more (e.g., five in this example) mobile devices 40. Then, the terminal 30 transmits the one or more (e.g., five in this example) pieces of received signal strength information thus acquired to the server 20 via the first network 50.

The terminal 30 normally further includes a processor and a memory (neither is shown). Various pieces of information such as the terminal identifier and program are stored in the memory. The processor operates in accordance with the information stored in the memory, thereby performing the functions of the terminal 30.

The terminal 30 may be, for example, a scanner or a beacon receiver. The terminal 30 is normally an immobile terminal. Alternatively, the terminal 30 may also be a mobile terminal if the current location of the terminal 30 is known.

Note that if the terminal 30 includes a transmitter, the terminal 30 transmits the wireless signal W10 with the terminal identifier of the terminal 30, for example,

### (2-6) Mobile Device

The mobile device 40 according to this embodiment transmits, from its transmitter, the wireless signal W10 with the mobile device identifier of the mobile device 40 as described above.

The mobile device 40 further includes a processor and a memory (neither is shown). Various pieces of information such as the mobile device identifier and program are stored in the memory. The processor operates in accordance with the information stored in the memory, thereby performing the functions of the mobile device 40.

The mobile device 40 is a device which is carried by a person with him or her and which moves along with him or her. The mobile device 40 may be, for example, a beacon transmitter or a mobile communications device. Examples of the mobile communications device include smartphones, tablet computers, and cellphones.

Optionally, the mobile device 40 may further include a communications module for use to establish a communication via at least one of the first network 50 or the second network 60. If the mobile device 40 includes a receiver, the received signal strength information acquired by the mobile device 40 may be transmitted to the server 20 via either the first network 50 or the second network 60.

### (2-7) Service Provider System and Terminal Device

The service provider system 70 may, for example, receive information about the result of the area determination (decision information (to be described later)) from the server 20, acquire various pieces of information such as information about the space utilization percentage based on the information thus received, and provide, based on the information thus acquired, services such as spatial management of a building via the terminal device 80.

Note that the space utilization percentage may be determined by, for example, locating the space where one or more (e.g., five in this example) mobile devices 40 are currently present based on one or more (e.g., 35 in this example) pieces of decision information received from the server 20 and by counting the number of the mobile devices 40 currently present in each of the one or more areas (e.g., the seven areas A10-A16).

The service provider system 70 and the terminal device 80 each include a communications module for establishing a communication via the second network 60, a processor, and a memory (none of which is shown). Various pieces of information such as a program are stored in the memory. The processor operates in accordance with the information stored in the memory, thereby performing the functions of the service provider system 70 and the terminal device 80.

### (2-8) Server

The server 20 receives the received signal strength information from either the terminal 30 or the mobile device 40 and makes area determination (including the first determination and the second determination) about the mobile device 40. Then, the server 20 transmits the result of the area determination (which is normally the result of the second determination) to the service provider system 70 via the second network 60.

The server 20 according to this embodiment receives three or more (e.g., 20 in this example) pieces of received signal strength information corresponding to the combinations of three or more (e.g., four in this example) terminals 30 and one or more (e.g., five in this example) mobile devices 40. The server 20 makes one or more (e.g., 35 in this example) area determinations corresponding to the combinations of the one or more areas (e.g., the seven areas A10-A16 in the space A1) and the one or more (e.g., five in this example) mobile devices 40 to obtain one or more (e.g., 35 in this example) decisions. Then, the server 20 transmits one or more (e.g., 35 in this example) pieces of decision information corresponding to the one or more (e.g., 35 in this example) decisions thus obtained to the service provider system 70 via the second network 60.

As used herein, the “decision information” refers to a piece of information about the decision (which is normally the result of the second determination). The decision information may include, for example, a set consisting of either presence information (which may be the flag “1”) or absence information (which may be flag “0”), the area identifier, and the terminal identifier.

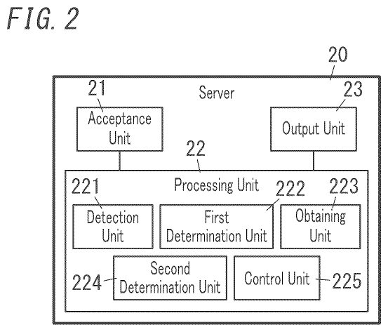

The server 20 includes a communications module for establishing a communication via the first network 50 and the second network 60, a processor, and a memory (none of which is shown). Various pieces of information such as the area location information, the terminal location information, and a program are stored in the memory. The processor operates in accordance with the information stored in the memory, thereby performing the functions (e.g., the functions of the respective constituent elements shown in FIG. 2) of the server 20.

### (2-9) Respective Constituent Elements of Server

Specifically, the server 20 includes the acceptance unit 21, a processing unit 22, and the output unit 23 as shown in FIG. 2. The processing unit 22 includes the detection unit 221, the first determination unit 222, the obtaining unit 223, the second determination unit 224, and the control unit 225.

### (2-9-1) Acceptance Unit

The acceptance unit 21 accepts various pieces of information. Examples of the various pieces of information include preset values of various types of parameters such as the received signal strength information, the predetermined length T, and the predetermined number of times N.

The acceptance may be, for example, the reception of information that has been transmitted via either the first network 50 or the second network 60. The acceptance may also include acceptance of information that has been entered via an input device such as a keyboard or a touchscreen panel and acceptance of information that has been read out from a storage medium such as a memory.

The acceptance unit 21 according to this embodiment receives the received signal strength information that the terminal 30 has transmitted via the first network 50. If the area determination system 10 has the configuration shown in FIG. 1, twenty pieces of received signal strength information, corresponding to the combinations of the four terminals 30 and the five mobile devices 40, are received either simultaneously or substantially simultaneously.

In addition, the acceptance unit 21 may also accept preset values (such as the numerical values of the predetermined length T and the predetermined number of times N; each of which may be either a fixed value or an initial value) which have been entered via the input device, for example.

### (2-9-2) Processing Unit

The processing unit 22 performs various types of processing. As used herein, the “various types of processing” may refer to, for example, processing about the area determination described above and specifically refer to the processing to be performed by the above-described principal constituent elements (namely, the detection unit 221, the first determination unit 222, the obtaining unit 223, the second determination unit 224, and the control unit 225). In addition, the processing unit 22 also makes some of the determinations to be described later with reference to the flowcharts shown in FIGS. 4-6.

If the area determination system 10 has the configuration shown in FIG. 1, then thirty-five area determinations respectively corresponding to the combinations of the seven areas A10-A16 and the five mobile devices 40 are performed in parallel with each other. Note that the phrase “in parallel with each other” may refer, for example, to time division processing to be performed by a single processor but may also be parallel processing to be performed by a plurality of processors.

### (2-9-3) Output Unit

The output unit 23 outputs various types of information, which include, for example, the result of the area determination.

The output unit 23 may output, for example, the decision made by the second determination unit 224 (such as the decision information described above). If the area determination system 10 has the configuration shown in FIG. 1, then thirty-five pieces of decision information respectively corresponding to the thirty-five area determinations by the processing unit 22 are output.

As used herein, the “output” may be, for example, transmission to the service provider system 70 via the second network 60 but may also include, for example, display on a display device, emission of a voice from a loudspeaker, and storage on a storage medium.

### (2-10) Memory and Information Stored in Memory

For example, in a memory (not shown) of the server 20, stored in advance are four pieces of terminal location information respectively corresponding to the four terminals 30 and seven pieces of area location information respectively corresponding to the seven areas A10-A11. As used herein, the “terminal location information” refers to information about the location of the terminal 30 and the “area location information” refers to information about the locations of the target areas (A10-A17).

The terminal location information may be, for example, coordinates. The coordinates according to this embodiment are two-dimensional coordinates (x, y). The two-dimensional coordinates (x, y) may be, for example, coordinates on an xy plane defined by the two axes, namely, an x-axis and a y-axis (neither is shown), which are aligned with the bottom surface of the space A1 shown in FIG. 3. Alternatively, the coordinates may also be, for example, three-dimensional coordinates (x, y, z) on an xyz plane defined by three axes, namely, the x-axis, the y-axis, and a z-axis in the height direction. Still alternatively, the coordinate may also be a one-dimensional coordinate (x) aligned with the x-axis.

The area location information may be, for example, a set of two coordinates respectively corresponding to the starting point and end point of the area. For example, the area location information corresponding to the area A10 may be “(X10s, Y10s) to (X10e, Y10e).”

Note that the memory in which the terminal location information and other pieces of information are stored may be, for example, the memory of the terminal 30 or the memory of the service provider system 70. The memory may be located anywhere without limitation as long as the processor of the server 20 may access the memory.

Also, the memory does not have to be a single memory. The memory may also be, for example, a set of a plurality of memory elements. Various types of information such as terminal location information may be stored to be distributed in the plurality of memory elements.

### (2-11) Location Detection by Reference to Information in Memory and Accumulation of Results of Detection

The location detection is performed by the detection unit 221 based on the received signal strength of the wireless signal W10 received by the receiver of the terminal 30 and the terminal location information stored in the memory.

That is to say, the detection unit 221 detects the location of a mobile device 40 by reference to four pieces of received signal strength information respectively corresponding to four terminals 30 and the terminal location information stored in the memory with respect to the wireless signal W10 received from the single mobile device 40.

In addition, when acquiring the mobile device location information by detecting the location of the mobile device 40, the detection unit 221 acquires timestamp information, indicating a point in time when the location detection has been made, from a built-in clock, for example, and accumulates the timestamp information in the memory in association with the mobile device location information. The set of the mobile device location information and timestamp information thus acquired is normally accumulated in the memory in association with the mobile device identifier.

As can be seen, every time the location of the mobile device 40 is detected, timestamp information is acquired, and the set of the mobile device location information and timestamp information thus acquired is accumulated one after another in the memory in association with the mobile device identifier.

The set of the mobile device location information and the timestamp information may be accumulated, for example, in the memory of the server but may also be accumulated in any other memory without limitation.

### (2-12) Control Method Performed by Control Unit

### (2-12-1) First Method

The control unit 225 according to this embodiment calculates, when the number of times n of decisions of presence is equal to or greater than the predetermined number of times N, the difference between two pieces of timestamp information respectively corresponding to two adjust pieces of presence information with respect to multiple pieces of presence information acquired during the target period. This allows one or more differences to be calculated.

In this embodiment, the initial value of the predetermined number of times N is “3” as described above, and therefore, the difference is not calculated if the number of times n of decisions of presence is “2.” Alternatively, even when the number of times n of decisions of presence is “2,” the difference may also be calculated.

The control unit 225 obtains the maximum difference (Δt) that is the maximum value of one or more differences thus calculated. Even if the number of times n of decisions of presence is equal to or greater than the predetermined number of times N but the maximum difference Δt is greater than the threshold value Δt0, the control unit 225 makes the second determination unit 224 decide that the mobile device 40 be absent from the target area (e.g., the area A10) during the target period.

The threshold value Δt0 may be, for example, k times (where 0<k<1) as large as the period length T of the target period, where k may be, for example, “½” or “⅔.”

### (2-12-2) Operation of Area Determination System (Server) According to First Method

The area determination system 10 (e.g., the server 20 in this embodiment) performs the processing following the procedure of the flowcharts shown in FIGS. 4-6. The series of processing steps shown in the flowcharts of FIGS. 4-6 start to be performed when the area determination system 10 (server 20) is booted.

Note that the flowcharts shown in FIGS. 4-6 show the series of processing steps to be performed with respect to one set (consisting of a single mobile device identifier and a single area identifier) out of multiple combinations (e.g., thirty-five sets) of one or more (e.g., five in this example) mobile devices 40 and one or more areas (e.g., the seven areas A10-A16), The area determination system 10 performs the same series of processing steps on each combination of a mobile device identifier and an area identifier. Specifically, the processing unit 22 of the server 20 performs, in parallel with each other, thirty-five series of processing respectively corresponding to thirty-five combinations of mobile device identifiers and area identifiers.

The processing unit 22 acquires timestamp information from, for example, a built-in clock (not shown) to set the timestamp information at a variable ts indicating the start time (in Step S1). Next, the processing unit 22 sets a variable n, indicating the number of times of decisions of presence, at an initial value “0” (in Step S2).

Next, the processing unit 22 determines whether an amount of time corresponding to the predetermined length T (hereinafter simply referred to as a “time T”) has passed since the start time ts (in Step S3). If the time T has not passed yet since the start time ts (Le., if the answer is NO in Step S3), then the processing unit 22 performs the location detection processing of detecting the location of the mobile device 40 (in Step S4). Note that the location detection processing will be described later.

Next, the first determination unit 222 determines whether the location detected in Step S4 falls within the target area A10 (in Step S5). If the location detected falls within the target area A10 (Le., if the answer is YES in Step S5), then the processing unit 22 associates presence information “1” with the location information acquired in Step S1 (in Step S6). Next, the processing unit 22 makes an increment to the variable n (in Step S7). Thereafter, the process returns to Step S3.

On the other hand, if a decision is made that the location detected in Step S4 falls outside of the target area A10 (i.e., if the answer is NO in Step S5), then the processing unit 22 associates the absence information “0” with the location information acquired in Step S1 (in Step S8). Thereafter, the process returns to Step S3.

If the time T has already passed since the start time ts (i.e., if the answer is YES in Step S3), the processing unit 22 adds the time T to the end time te (in Step S9). Next, the second determination unit 224 determines whether the number of times n of decisions of presence is equal to or greater than the predetermined number of times N (in Step S10).

If the number of times n of decisions of presence is equal to or greater than the predetermined number of times N (i.e., if the answer is YES in Step S10), then the obtaining unit 223 obtains the maximum difference Δt between adjacent “present” times (in Step S11). Next, the control unit 225 determines whether the maximum difference At obtained in Step S11 is equal to or less than the threshold value Δt0 (in Step S12).

If the maximum difference Δt is equal to or less than the threshold value Δt0 (i.e., if the answer is YES in Step S12), then the second determination unit 224 associates the presence information “1” with the period information “ts-te” as a combination of the start time ts and the end time te (in Step S13).

If the number of times n of decisions of presence is not equal to or greater than the predetermined number of times N. (i.e., if the answer is NO in Step S10), then the second determination unit 224 associates the absence information “0” with the period information “ts-te” (in Step S14). Also, even if the number of times n of decisions of presence is equal to or greater than the predetermined number of times N but the maximum difference Δt is not equal to or less than the threshold value Δt0 (i.e., if the answer is NO in Step S12), then the control unit 225 instructs the second determination unit 224 to associate the absence information “0” with the period information “ts-te,” thereby performing Step S13,

When either Step S13 or Step S14 has been performed, the process ends. When the process finishes being performed on every possible combination of the mobile device identifier and the area identifier, the process starts to be performed on the next target period.

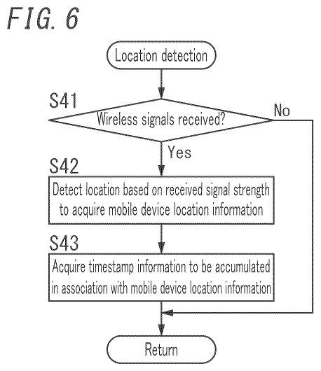

The location detection processing of Step S4 may be performed, for example, following the procedure of the flowchart shown in FIG. 6.

The detection unit 221 determines whether three or more (e.g., four in this example) receivers corresponding to three or more (e.g., four in this example) terminals 30 have received the wireless signals W10 from the mobile device 40 (in Step S41).

If the four terminals 30 have received the wireless signals W10 from the mobile device 40 (i.e., if the answer is YES in Step S41), then the detection unit 221 detects the location of the mobile device 40 based on the four received signal strengths corresponding to the four wireless signals W10 received to acquire mobile device location information (in Step S42).

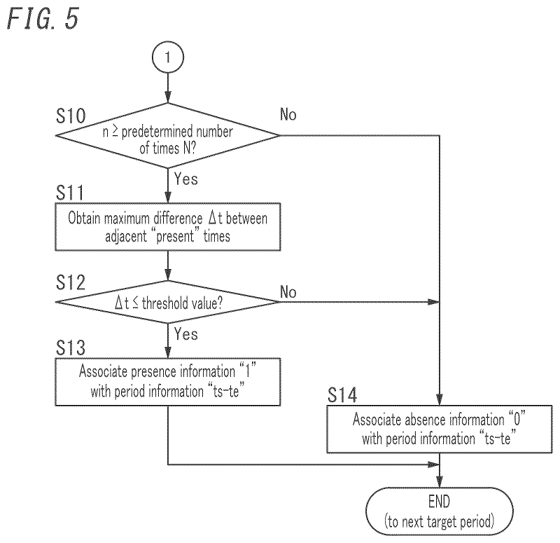

Next, the detection unit 221 acquires, from the built-in memory, for example, the timestamp information at a point in time when the location detection is performed in Step S42 and accumulates the timestamp information in association with the mobile device location information acquired in Step S42 (in Step S43). Thereafter, the process returns to the series of high-order processing steps (refer to FIGS. 4 and 5).

### (2-12-3) Specific Example According to First Method

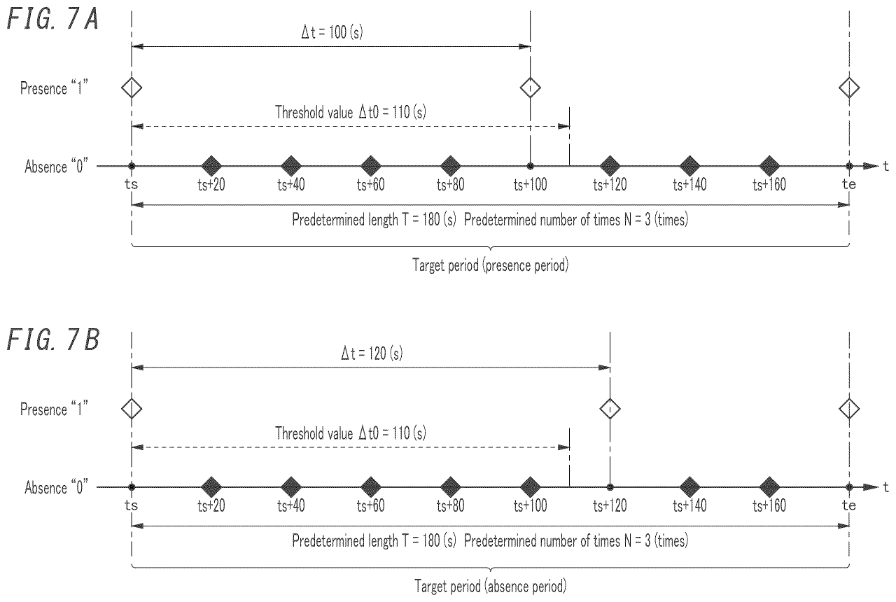

In this example, the predetermined length T is 180 seconds, the predetermined number of times N is three times, and the threshold value Δt0 is 110 seconds as shown in FIGS. 7A and 7B.

In the target period “ts-te,” the end time te is calculated by adding 180 seconds to the start time ts (i.e., te=ts+180). The location information acquisition cycle is 20 seconds. Thus, ten pieces of location information are acquired during 180 seconds from the start time ts through the end time te. In this example, the location information acquisition cycle is supposed to be 20 seconds for the sake of convenience. Normally, the location information is acquired in a shorter cycle time (e.g., every second).

Out of the ten pieces of location information thus acquired, the timestamp information “ts” is associated with the first piece of location information, the timestamp information “ts+20” is associated with the second piece of location information, and the timestamp information “te” is associated with the tenth piece of location information.

In addition, either presence information “1” or absence information “0” is associated with each of the ten pieces of location information “ts,” “ts+20,” . . . and “te” respectively corresponding to the ten pieces of location information. In the example shown in FIG. 7A, the presence information “1” is associated with each of three pieces of location information, namely, the first, sixth, and tenth pieces of the location information, while the absence information “0” is associated with the other seven pieces of location information. In the example shown in FIG. 7B, the presence information “1” is associated with each of three pieces of location information, namely. the first, seventh, and tenth pieces of the location information, while the absence information “0” is associated with the other seven pieces of location information.

Thus, in the example shown in FIG. 7A, the difference of 100 seconds between the first and sixth pieces of timestamp information and the difference of 80 seconds between the sixth and tenth pieces of timestamp information are obtained, and therefore, the maximum difference Δt will be 100 seconds. This maximum difference Δt (=100 seconds) is less than the threshold value Δt0 (=110 seconds), and therefore, the target period is determined to be a “presence period.”

On the other hand, in the example shown in FIG. 7B, the difference of 120 seconds between the first and seventh pieces of timestamp information and the difference of 60 seconds between the seventh and tenth pieces of timestamp information are obtained, and therefore, the maximum difference Δt will be 120 seconds. This maximum difference Δt (=120 seconds) is equal to or greater than the threshold value Δt0 (=110 seconds), and therefore, the target period is determined to be an “absence period.”

As can be seen, according to this embodiment (i.e., the first method), even if the number of times n of decisions of presence is the same (e.g., n=3 in this embodiment) but the time interval between the decisions of presence (e.g., the maximum difference Δt) is equal to or greater than the threshold value Δt0, the target period is determined to be an absence period. This contributes to improving the accuracy of decision when a person carrying the mobile device leaves the room around the end of the target period, for example.

Consequently, according to this embodiment, using the maximum difference Δt between multiple points in time corresponding to multiple decisions of presence during the target period contributes to improving the accuracy of decision.

### (2-12-4) First Variation of Control: Second Method

If the first determination unit 222 continues to make decisions similar to the decision made by the second determination unit 224 during the target period even after the target period has passed, then the control unit 225 extends the target period.

As used herein, the expression “similar decisions are made even after the target period has passed” may refer to, for example, a situation where a decision similar to the decision made by the second determination unit 224 during the target period is made again by the first determination unit 222 within a predetermined time ΔT from the end of the target period.

As used herein, to extend the target period means, for example, postponing the end of the target period for the predetermined time ΔT. Note that the amount of time for which the target period is extended may be either longer or shorter than the predetermined time ΔT, whichever is appropriate.

The control unit 225 according to this embodiment postpones, since the end of the target period has been postponed for the predetermined time ΔT, each of the beginning and the end of the next target period for ΔT as well. As a result, the next target period is postponed for ΔT with the same period length T maintained.

Optionally, even when the end of the target period has been postponed for ΔT, the control unit 225 does not have to postpone the beginning or end of the next target period at all. This causes the target period and the next target period to partially overlap with each other.

Alternatively, in a situation where the end of the target period has been postponed for ΔT, the control unit 225 may postpone only the beginning of the next target period for ΔT without postponing the end of the next target period at all. This causes no overlap between the target period and the next target period and shortens the period length T of the next target period to “T-ΔT.”

As can be seen, according to the first variation of control (second method), if the first determination unit 222 continues to make similar decisions even after the second determination unit 224 has made the decision with respect to the target period, the accuracy of the decision may be improved by extending the target period.

### (2-12-5) Period Extension When Decisions of Presence Are Made Continuously

Specifically, if the first determination unit 222 decides, within the predetermined time ΔT since the second determination unit 224 has decided that the mobile device 40 be present in the target area (such as the area A10) during the target period, for example, that the mobile device 40 be present in the target area A10, then the control unit 225 postpones the end of the target period for the predetermined time ΔT.

That is to say, if the second determination unit 224 has acquired the presence information during the target period and the first determination unit 222 acquires again the presence information before the predetermined time ΔT passes since the end time te indicating the end of the target period (i.e., before the point in time “te+ΔT”), for example, then the control unit 225 postpones the end of the target period for the predetermined time ΔT. On the other hand, unless the presence information is acquired again within the predetermined time ΔT, the end of the target period will be the beginning of the next target period, for example.

As can be seen, if the first determination unit 222 continues to make decisions of presence even after the second determination unit 224 has made the decision of presence with respect to the target period, the accuracy of decision may be improved by extending the target period.

### (2-12-6) Period Extension When Decisions of Absence Are Made Continuously

If the first determination unit 222 decides, within the predetermined time ΔT since the second determination unit 224 has decided that the mobile device 40 be absent from the target area (such as the area A10) during the target period, for example, that the mobile device 40 be absent from the target area A10, then the control unit 225 postpones the end of the target period for the predetermined time ΔT.

That is to say, if the second determination unit 224 has acquired the absence information during the target period and the first determination unit 222 acquires again the absence information before the predetermined time ΔT passes since the end time te indicating the end of the target period (i.e., before the point in time “te+ΔT”), for example, then the control unit 225 postpones the end of the target period for the predetermined time ΔT. On the other hand, unless the absence information is acquired again within the predetermined time ΔT, the end of the target period will be the beginning of the next target period, for example.

Note that the predetermined time ΔT when determining whether the absence information has been acquired again and the predetermined time ΔT when determining whether the presence information has been acquired again normally have the same length but may also have mutually different lengths.

As can be seen, if the first determination unit 222 continues to make decisions of absence even after the second determination unit 224 has made the decision of absence with respect to the target period, the accuracy of the decision may be improved by extending the target period.

### (2-12-7) Operation of Area Determination System (Server) According to Second Method

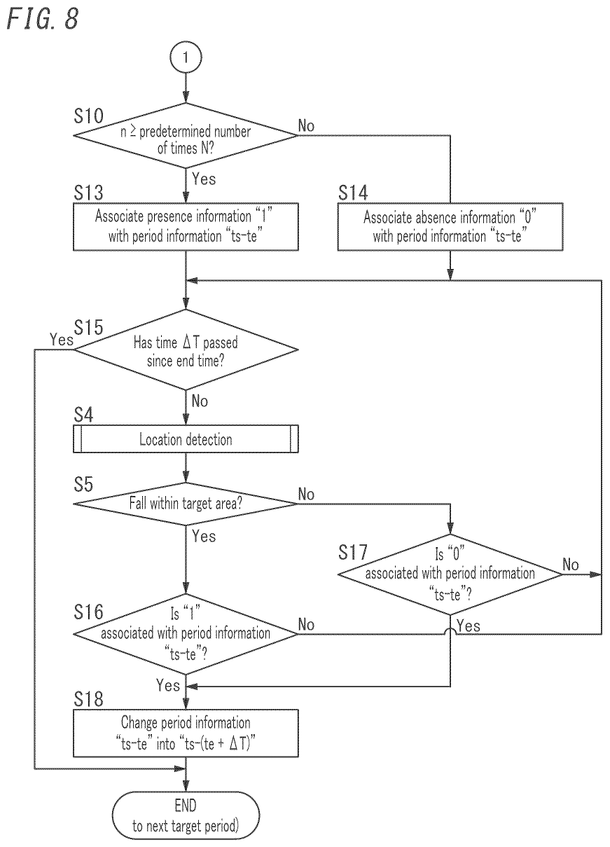

The area determination system 10 (i.e., the server 20 in this embodiment) performs the processing following the flowcharts shown in FIGS. 4, 6, and 8. Note that since the processing shown in FIGS. 4 and 6 has already been described, the processing shown in FIG. 8 will be described.

The processing shown in FIG. 8 has all the processing steps of the processing shown in FIG. 5 but the two processing steps S11 and S12 and further includes six additional processing steps S15, S4, S5, and S16-S18.

As described above, Step S10 includes determining whether the number of times n of decisions of presence is equal to or greater than the predetermined number of times N. If the answer is YES in Step S10, the process proceeds to Step S13. On the other hand, if the answer is NO in Step S10, then the process proceeds to Step S14.

As described above, Step S13 includes associating the presence information “1” with the period information “ts-te.” StepS14 includes associating the absence information “0” with the period information “ts-te.” After performing either Step S13 or Step S14, the control unit 225 determines whether the predetermined time ΔT has passed since the end time te (in Step S15).

If the predetermined time ΔT has not passed yet since the end time (i.e., if the answer is NO in Step S15), Steps S4 and S5 are performed. As described above, Step S4 includes detecting the location of the mobile device 40. Step S5 includes determining whether the detected location falls within the target area A10.

If the detected location falls within the target area A10 (i.e., if the answer is YES in Step S5), the control unit 225 determines whether the presence information “1” is associated with the period information “ts-te” (in Step S16). On the other hand, unless the detected location falls within the target area A10 (i.e., if the answer is NO in Step 85), the control unit 225 determines whether the absence information “0” is associated with the period information “ts-te” (in Step S17).

If the presence information “1” is associated with the period information “ts-te” (i.e., if the answer is YES in Step S16) or if the absence information “0” is associated with the period information “ts-te” (i.e., if the answer is YES in Step S17), then the control unit 225 changes the period information “ts-te” into “ts-te+ΔT” (in Step S18).

If the answer is NO in Step S16 or if the answer is NO in Step S17, then the process returns to Step S15.

Either after Step S18 has been performed or if the predetermined time ΔT has already passed since the end time te (i.e., if the answer is YES in Step S15), then the process ends. When the processing is done with respect to every possible combination of the mobile device identifier and the area identifier, processing starts to be performed with respect to the next target period.

### (2-12-8) Specific Example According to Second Method

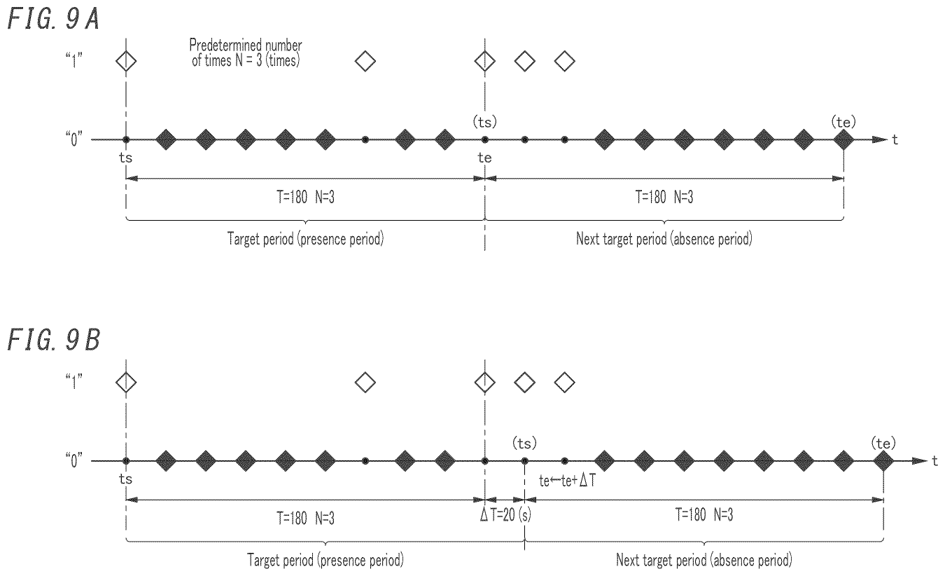

FIGS. 9A and 9B show exemplary decisions made by the first determination unit 222 (where the decision of presence “1” is indicated by the open diamond and the decision of absence “0” is indicated by the solid diamond) and exemplary decisions made by the second determination unit 224 (which is either “presence period” or “absence period”) with respect to the target period and the next target period.

The example shown in PIGS. 9A and 9B represents a situation where the mobile device 40 has been present in the area A10 through the target period “ts-te” and has left the area A10 when approximately 50 seconds has passed since the end te of the target period (=the beginning ts of the next target period).

In this example, the predetermined time ΔT is 20 seconds as shown in FIG. 9B. Note that FIG. 9A shows, for the purpose of comparison, a situation where the control according to the second method (i.e., extension of the target period) is not performed.

In this example, as in the specific example according to the first method (refer to FIGS. 7A and 7B), the predetermined length T is 180 seconds, and the predetermined number of times N is three times as shown in FIGS. 9A and 9B.

Although not shown, in the target period “ts-te,” the end time te is a time calculated by adding 180 seconds to the start time ts (i.e., te=ts+180), the location information acquisition cycle is 20 seconds, and ten pieces of location information are acquired during 180 seconds from the start time ts through the end time te.

In FIG. 9A, the number of times n of decisions of presence in the target period “ts-te” is three and the number of times n of decisions of presence in the next target period “ts-te” is also three. In the target period “ts-te,” the presence information “1” is acquired three times, namely, for the first, seventh, and tenth decisions, and the absence information “0” is acquired seven times, namely, for the second to sixth decisions, the eighth decision, and the ninth decision. In the next target period “ts-te,” the presence information “1” is acquired three times, namely, for the first to third decisions, and the absence information “0” is acquired seven times, namely, for the fourth to tenth decisions.

Therefore, unless the control according to the second method (i.e., extension of the target period) is performed, the target period and the next target period are both determined to be presence periods as shown in FIG. 9A. That is to say, the next target period is determined to be a presence period even though the decision of absence is made every time once 50 seconds has passed since the beginning.

On the other hand, as shown in FIG. 9B, in a situation where the control according to the second method is performed, after the second determination unit 224 has determined the target period “ts-te” to be a presence period, the first determination unit 222 acquires again the presence information “1” within the predetermined time ΔT (=20 seconds) since the end te of the target period “ts-te.” Thus, the control unit 225 extends the target period “ts-te” for the predetermined time ΔT (=20 seconds).

In FIG. 9B, since the target period “ts-te” has been extended, the next target period “ts-te” is postponed for the predetermined time ΔT (=20 seconds). Thus, the number of times n of decisions of presence in the next target period “ts-te” will be two. That is to say, the number of times n of decisions of presence is less than the predetermined number of times N. Consequently, the second determination unit 224 deter s the next target period “ts-te” to be an absence period.

As can be seen, according to the first variation of control (i.e., according to the second method), a decision indicating that the decision of absence is made every time once 50 seconds has passed since the beginning is obtained with respect to the next target period, thus improving the accuracy of decision.

### (2-12-9) Second Variation of Control: Third Method

The control unit 225 according to this variation adopts, depending on the decision made by the second determination unit 224 during the target period, a weighted value, calculated by adding a weight to a value for the target period, with respect to at least one of the predetermined length T or the predetermined number of times N in the next target period following the target period.

### (2-12-10) Adopting First Weighted Value and/or Second Weighted Value After Decision of Absence Has Been Made

Specifically, if the second determination unit 224 has decided that the mobile device 40 be absent from the target area (such as the area A10) during the target period, for example, the control unit 225 adopts at least one of a first weighted value for the predetermined length T or a second weighted value for the predetermined number of times N in the next target period.

As used herein, the “first weighted value” refers to a value calculated by multiplying the value of the predetermined length T in the target period by a weighting coefficient α1 less than 1 (i.e., α1×T, where α1<1). The “second weighted value” as used herein refers to a value calculated by multiplying the value of the predetermined number of times N in the target period by a weighting coefficient β1 greater than 1 (i.e., β1×N, where β1>1).

As can be seen, adopting at least one of the first weighted value (α1×T, where α1<1) or the second weighted value (β1×N, where β1>1) for the next target period in response to the decision of absence with respect to the target period contributes to improving the accuracy of decision.

### (2-12-11) Adopting First Weighted Value After Decision of Absence Has Been Made in Reserved Period

If the second determination unit 224 has decided that the mobile device 40 be absent from the target area (such as the area A10) during the target period and the next target period overlaps with a reserved period for the target area A10, then the control unit 225 adopts the first weighted value for the predetermined length T in the next target period.

Specifically, reservation information is stored in a memory, for example. As used herein, the “reservation information” refers to a piece of information which may be used to identify a reserved period for the target area (such as the area A10). The reservation information may include, for example, reserved period information. As used herein, the “reserved period information” refers to a piece of information indicating the reserved period. The reserved period information may be, for example, a combination of a start time and an end time but may also be a combination of a start time and a usage time.

In this embodiment, seven pieces of reservation information respectively corresponding to the seven areas A10-A16 shown in FIG. 3 are stored in the memory in association with the area identifier, Optionally, the reservation information may include vacant period information, indicating a non-reserved vacant period, instead of, or in addition to, the reserved period information. Alternatively, the reservation information may also be a piece of information simply indicating whether there is any reservation.

As can be seen, if the next target period overlaps with the reserved period, adopting the first weighted value for the next target period in response to the decision of absence with respect to the target period contributes to improving the accuracy of the decision.

Optionally, the control unit 225 may adopt not only the first weighted value for the predetermined length T but also a second weighted value for the predetermined number of times N as well.

### (2-12-12) Adopting Third Weighted Value and/or Fourth Weighted Value After Decision of Presence Has Been Made

If the second determination unit 224 has decided that the mobile device 40 be present in the target area (such as the area A10) during the target period, for example, the control unit 225 adopts at least one of a third weighted value for the predetermined length T or a fourth weighted value for the predetermined number of times N in the next target period.

As used herein, the “third weighted value” refers to a value calculated by multiplying the value of the predetermined length T in the target period by a weighting coefficient α2 greater than 1 (i.e., α2×T, where α2>1). The “fourth weighted value” as used herein refers to a value calculated by multiplying the value of the predetermined number of times N in the target period by a weighting coefficient β2 less than 1 (i.e., β2×N, where β2<1).

As can be seen, adopting at least one of the third weighted value (α2×T, where α2>1) or the fourth weighted value (β2×N, where β2<1) for the next target period in response to the decision of presence with respect to the target period contributes to improving the accuracy of decision.

### (2-12-13) Adopting Third Weighted Value After Decision of Presence Has Been Made in Reserved Period

If the second determination unit 224 has decided that the mobile device 40 be present in the target area (such as the area A10) during the target period and the next target period overlaps with a reserved period for the target area A10, then the control unit 225 adopts the third weighted value for the predetermined length T in the next target period.

As can be seen, if the next target period overlaps with the reserved period, adopting the third weighted value (α2×T, where α2>1) for the next target period in response to the decision of presence with respect to the target period contributes to improving the accuracy of the decision.

Optionally, the control unit 225 may adopt not only the third weighted value (α2×T; where 2>1) for the predetermined length T but also the fourth weighted value (β2×T, where β2<1) for the predetermined number of times N as well.

### (2-12-14) Operation of Area Determination System (Server) According to Third Method

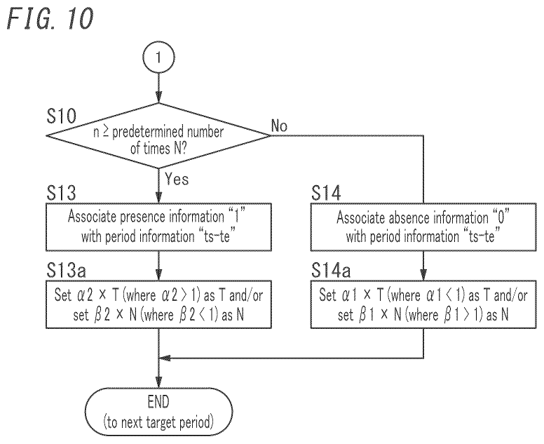

The area determination system 10 (i.e., the server 20 in this embodiment) performs the processing following the flowcharts shown in FIGS. 4. 6, and 10. Note that since the processing shown in FIGS. 4 and 6 has already been described, the processing shown in FIG. 10 will be described.

The processing shown in FIG. 10 bas all the processing steps of the processing shown in FIG. 8 (according to the second method) but the six processing steps S15, S4. S5, and S16-S18 and further includes, as additional processing steps, Step S13a to be performed after Step S13 and Step S14a to be performed after Step S14.

Step S13a includes at least one of setting “α2×T” (where α2>1) as the variable T or setting “β2×N” (where β2<1) as the variable N.

Step S14a includes at least one of setting “α1×T” (where α1<1) as the variable T or setting “β1×N” (where β1>1) as the variable N.

After either Step S13a or Step 14a has been performed, the process ends. When the process finishes being performed on every possible combination of the mobile device identifier and the area identifier, the process starts to be performed on the next target period.

### (2-12-15) Specific Example According to Third Method

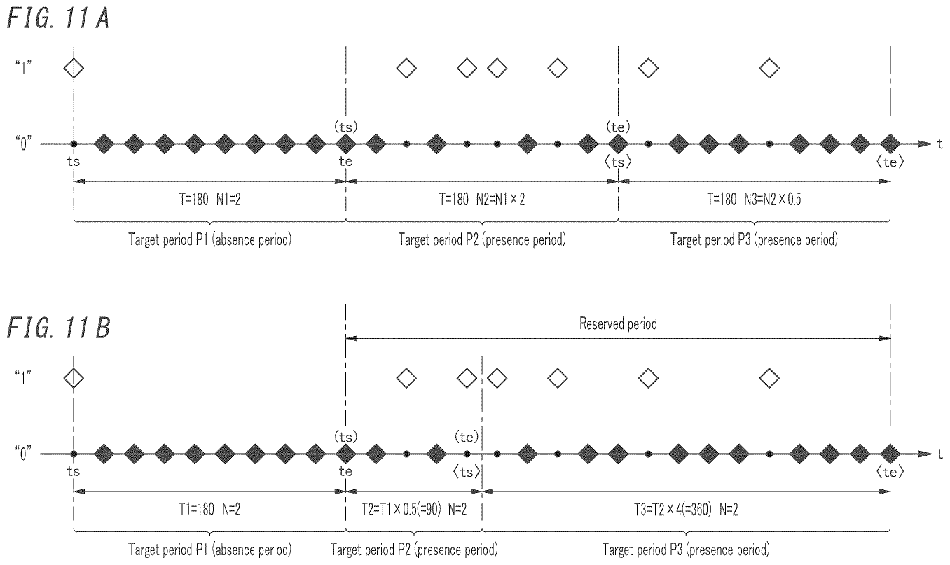

FIGS. 11A and 11B show exemplary decisions made by the first determination unit 222 (where the decision of presence “1” is indicated by the open diamond and the decision of absence “0” is indicated by the solid diamond) and exemplary decisions made by the second determination unit 224 (which is either “presence period” or “absence period”) with respect to three consecutive target periods P1-P3.

The example shown in FIGS. 11A and 11B represents a situation where the mobile device 40 is absent from the area A10 in the first target period P1 “ts-te,” enters the area A10 when approximately 30 seconds has passed since the end te of the target period P1 (i.e., the beginning ts of the next target period P2), and has been present in the area A10 for the remaining 150 seconds of the next target period P2 “ts-te” and for 180 seconds of the target period P3 “ts-te” following the next target period P2 “ts-te.”

In the example shown in FIG. 11A, the target of control for the control unit 225 is the predetermined number of times N. The predetermined number of times N changes from N1 in the target period P1 into N2 in the target period P2 and then into N3 in the target period P3. Meanwhile, the predetermined length T remains constant (=180 seconds) throughout the target periods P1-P3.

In the target period P1, the predetermined number of times N1 is “2” while the number of times n of decisions of presence is “1” as shown in FIG. 11A. Thus, since n<N1, the target period P1 is determined to be an absence period. In accordance with this decision, the control unit 225 adopts the second weighted value “β1×N” (where β1>1; β1=2 in this example) for the predetermined number of times N (refer to Step S14a). As a result, the predetermined number of times N2 in the next target period P2 becomes twice as large as the predetermined number of times N1 in the target period P1 (N2=2×N1=4).

In the target period P2, the predetermined number of times N2 is “4” while the number of times n of decisions of presence is “4,” Thus, since n≥N2, the target period P2 is determined to be a presence period. In accordance with this decision, the control unit 225 adopts the fourth weighted value “β2×N” (where β2<1; β2=0.5 in this example) for the predetermined number of times N (refer to Step S13a). As a result, the predetermined number of times N3 in the next target period P3 becomes 0.5 times as large as the predetermined number of times N2 in the target period P2 (N3=0.5×N2=2).

In the target period P3, the predetermined number of times N3 is “2” while the number of times n of decisions of presence is “2.” Thus, since n≥N3, the target period P3 is determined to be a presence period. In accordance with this decision, the control unit 225 may adopt the second weighted value “β1×N” (where β1<1; β2=0.5 in this example) for the predetermined number of times N. As a result, the predetermined number of times (N4) in the next target period (P4) (not shown) becomes 0.5 times as large as the predetermined number of times N3 in the target period P3 (N4=0.5×N3=1).

As can be seen, in a target period following an absence period, the decision about the transition from an absence state into a presence state needs to be made so accurately that the second weighted value “β1×N” (where β1>1) is adopted to increase the predetermined number of times N. This contributes to improving the accuracy of decision about the transition from the absence state into the presence state.

In addition, in a target period following the presence period, the presence state is highly likely to persist. Thus, the first weighted value “β2×N” (where β2<1) is adopted to decrease the predetermined number of times N. This contributes to improving the accuracy of decision about the transition from the presence state into the absence state. In other words, decreasing the predetermined number of times N in a situation where the presence state is highly likely to persist would reduce the chances of making an erroneous decision about the transition from the presence state into the absence state (i.e., deciding, by mistake, that a transition have been made from the presence state into the absence state even though the presence state actually persists).

Note that making a decision about the transition from the presence state into the absence state generally does not require as high accuracy as making a decision about the transition from the absence state into the presence state, and therefore, the accuracy of decision is sometimes allowed to decline due to a decrease in the predetermined number of times N.

Thus, changing the predetermined number of times N in the next target period depending on the decision made by the second determination unit 224 in a target period contributes to improving the accuracy of decision.

In the example shown in FIG. 11B, two target periods P2 and P3 out of the three target periods P1-P3 belong to a reserved period and target of control for the control unit 225 is the predetermined length T. The predetermined length T changes from T1 in the target period P1 into T2 in the target period P2 and then into T3 in the target period P3. Meanwhile, the predetermined number of times N remains constant (=2) throughout the target periods P1-P3.

In the target period P1, the predetermined length T1 is “180 seconds” while the number of times n of decisions of presence is “1” as shown in FIG. 11B. Thus, since n<N, the target period P1 is determined to be an absence period. In accordance with this decision, the control unit 225 adopts the first weighted value “α1×T” (where α1<1; α1=0.5 in this example) for the predetermined length T (refer to Step S14a). As a result, the predetermined length T2 in the next target period P2 becomes 0.5 times as long as the predetermined length T1 in the target period P1 (T2=0.5×T1=90 seconds).

In the target period P2 having the predetermined length T2 (=90 seconds), the predetermined number of times N is “2” while the number of times n of decisions of presence is “2.” Thus, since n≥N, the target period P2 is determined to be a presence period. In accordance with this decision, the control unit 225 adopts the third weighted value “α2×T” (where α2>1; α2=4 in this example) for the predetermined length T (refer to Step S13a). As a result, the predetermined length T3 in the next target period P3 becomes four times as long as the predetermined length T2 in the target period P2 (T3=4×T2=360 seconds).

In the target period P3, the predetermined number of times N is “2” while the number of times n of decisions of presence is “4.” Thus, since n≥N, the target period P3 is determined to be a presence period. In accordance with this decision, the control unit 225 may adopt the third weighted value “α2×T” (where α2>1; α2=4 in this example) for the predetermined length T. As a result, the predetermined length (T4) in the next target period (P4) (not shown) becomes four times as long as the predetermined length T3 in the target period P3 (T4=4×T3=1440 seconds).

As can be seen, in a target period following an absence period, a decision about the transition from an absence state into a presence state needs to be made so accurately (in particular, the two target periods P2 and P3 belong to a reserved period, and therefore, a transition from the absence state into the presence state is highly likely to be made in the target period P2) that the first weighted value “α1×T” (where α1<1) is adopted to increase the predetermined length T. This contributes to improving the accuracy of decision about the transition from the absence state into the presence state.

In addition, in a target period following the presence period, the presence state is highly likely to persist (in particular, the two target periods P2 and P3 belong to a reserved period, and therefore, the presence state is even more likely to persist in the target period P3). Thus, the third weighted value “α2×T” (where α2>1) is adopted to increase the predetermined length T. This contributes to improving the accuracy of decision about the transition from the presence state into the absence state. In other words, increasing the predetermined length T in a situation where the presence state is highly likely to persist would reduce the chances of making an erroneous decision about the transition from the presence state into the absence state.

Note that the decision about the transition from the presence state into the absence state generally does not require as high accuracy as the decision about the transition from the absence state into the presence state, and therefore, the accuracy of decision is sometimes allowed to decline due to extension of the predetermined length T.

Thus, changing the predetermined length T in the next target period depending on the decision made by the second determination unit 224 in a target period contributes to improving the accuracy of decision.

Optionally, in this example, at least one of an upper limit value (such as 10) or a lower limit value (such as 2) may be set in advance with respect to the predetermined number of times N. If the predetermined number of times N is greater than the upper limit value, then the predetermined number of times N will be the upper limit value. If the predetermined number of times N is less than the lower limit value, then the predetermined number of times N will be the lower limit value. In the same way, at least one of a lower limit value (such as 60 seconds) or an upper limit value (such as 600 seconds) may be set in advance with respect to the predetermined length T. If the predetermined length T is less than the lower limit value, then the predetermined length T will be the lower limit value. If the predetermined length T is greater than the upper limit value, then the predetermined length T will be the upper limit value.

In this example, if the second weighted value “β1×N” (where β1>1) is adopted a number of times continuously, then the weighting coefficient β1 in the second weighted value “β1×N” adopted later may be smaller than the weighting coefficient β1 in the second weighted value “β1×N” adopted earlier. This may reduce the chances of causing an increase in the second weighted value “β1×N” even when the second weighted value “β1×N” is adopted a number of times continuously.

In the same way, if the third weighted value “α2×T” (where α2>1) is adopted a number of times continuously, then the weighting coefficient β2 in the third weighted value “α2×T” adopted later may be smaller than the weighting coefficient α2 in the third weighted value “α2×T” adopted earlier. This may reduce the chances of causing an increase in the third weighted value “α2×T” even when the third weighted value “α2×T” is adopted a number of times continuously.

Also, if the first weighted value “α1×T” (where α1<1) is adopted a number of times continuously, then the weighting coefficient α1 in the first weighted value “α1×T” adopted later may be larger than the weighting coefficient α1 in the first weighted value “α1×T” adopted earlier. This may reduce the chances of causing a decrease in the first weighted value “α1×T” even when the first weighted value “α1×T” is adopted a number of times continuously.

Furthermore, if the fourth weighted value “β2×N” (where β2<1) is adopted a number of times continuously, then the weighting coefficient β2 in the fourth weighted value “β2×N” adopted later may be larger than the weighting coefficient β2 in the fourth weighted value “β2×N” adopted earlier. This may reduce the chances of causing a decrease in the fourth weighted value “β2×N” even when the fourth weighted value “β2×N” is adopted a number of times continuously.

As can be seen, according to the second variation of control (i.e., according to the third method), adding a weight to at least one of the predetermined length T or the predetermined period T in the next target period depending on the decision made on a target period contributes to improving the accuracy of decision.

### (3) Variations of Area Determination System

Alternatively, the area determination system 10 may include no server 20 and any one of the three or more terminals 30 may have the function of the server 20. That is to say, the area determination system 10 may be made up of three or more terminals 30 including one terminal 30 having the server function.

Also, the number of the terminals 30 that form the area determination system 10 may also be two or one. Furthermore, the area determination system 10 may include no terminals 30 and the server 20 may have the function of the one terminal 30. That is to say, the area determination system 10 may also be implemented as only the server 20.

### (4) Area Determination Method and Program

Note that various functions of the area determination system 10 (server 20) according to the exemplary embodiment described above may also be implemented as, for example, a method for increasing a value added, a (computer) program, or a non-transitory storage medium on which the program is stored. Note that the area determination method is a method including at least Step S4 (detection step). Step S5 (first determination step), Step S7 (obtaining step), Steps S10, S13, and S14 (second determination step), Steps S11 and S12, Steps S15 and S18, and Steps S13a and S14b (control step) out of the respective processing steps described above.

Also, the program is designed to cause one or more processors to perform the area determination method described above. The one or more processors may be, for example, the processor of the server 20. In addition, the one or more processors may include three or more processors respectively corresponding to three or more terminals 30 and may further include the processor of the mobile device 40 and/or the processor of the service provider system 70. Alternatively, the one or more processors may also be, for example, the processor of the one terminal 30 out of three or more terminals 30.

### (5) Recapitulation

An area determination system (10) according to a first aspect of the present disclosure includes a detection unit (221), a first determination unit (222), an obtaining unit (223), a second determination unit (224), and a control unit (225). The detection unit (221) detects, based on a received signal strength of a wireless signal (W10) being transmitted and received to/from a mobile device (40), location of the mobile device (40) to acquire mobile device location information indicating a result of detection. The first determination unit (222) determines, based on the mobile device location information, whether the mobile device (40) is present in a target area (A10). The obtaining unit (223) obtains a number of times (n) of decisions of presence. The number of times (n) of decisions of presence indicates a numerical number of times that the first determination unit (222) has decided that the mobile device (40) be present in the target area (A10) during a target period having a predetermined length (T). The second determination unit (224) decides, when the number of times (n) of decisions of presence is equal to or greater than a predetermined number of times (N), that the mobile device (40) be present in the target area (A10) during the target period and decides, when the number of times (n) of decisions of presence is less than the predetermined number of times (N), that the mobile device (40) be absent from the target area (A10) during the target period. The control unit (225) controls, using at least one selected from the group consisting of a time lag between multiple decisions of presence during the target period, the predetermined length (T), and the predetermined number of times (N), either determination processing by the second determination unit (224) or decisions made by the second determination unit (224),

This aspect contributes to more accurately determining whether the mobile device (40) is present in, or absent from, the target area.

In an area determination system (10) according to a second aspect, which may be implemented in conjunction with the first aspect, the mobile device (40) includes one member selected from the group consisting of a transmitter that transmits the wireless signal (W10) either at regular intervals or at irregular intervals and a receiver that receives the wireless signal (W10). The detection unit (221) detects, via a terminal (30) including the other member selected from the group consisting of the transmitter and the receiver, the location of the mobile device (40) based on a received signal strength of the wireless signal (W10) at the receiver.

This aspect may provide a server (20) contributing to more accurately determining, via the terminal (30), whether the mobile device (40) is present in, or absent from, the target area.

In an area determination system (10) according to a third aspect, which may be implemented in conjunction with the first or second aspect, the detection unit (221) acquires timestamp information indicating a point in time when the location has been detected and accumulates the timestamp information in association with the mobile device location information. The first determination unit (222) accumulates, in association with the timestamp information. either presence information indicating a decision of presence or absence information indicating a decision of absence.

This aspect allows the number of times of decisions of presence to be obtained a posteriori by counting the number of pieces of timestamp information belonging to a predetermined period which are associated with presence information by reference to the storage (i.e., a memory). In addition, this aspect also makes it easier to obtain the time lag (e.g., the maximum difference Δt) between multiple decisions of presence. Furthermore, this aspect also makes it easier to perform control using one or more selected from the group consisting of the time lag, the predetermined length (T), and the predetermined number of times (N).

In an area determination system (10) according to a fourth aspect, which may be implemented in conjunction with the third aspect, when the number of times (n) of decisions of presence is equal to or greater than the predetermined number of times (N), the control unit (225) calculates a difference between two pieces of timestamp information corresponding to two pieces of presence information acquired during the target period which are adjacent to each other and obtains a maximum difference (Δt) that is a maximum value of one or more differences thus calculated. Even when the number of times (n) of decisions of presence is equal to or greater than the predetermined number of times (N) but the maximum difference (Δt) is greater than a threshold value (Δt0), the control unit (225) also makes the second determination unit (224) decide that the mobile device (40) be absent from n the target area (A10) during the target period.

This aspect (i.e., a first method) contributes to improving the accuracy of decision by using the maximum difference (Δt) that is the maximum value of the time lag between multiple decisions of presence during the target period.

In an area determination system (10) according to a fifth aspect, which may be implemented in conjunction with any one of the first to fourth aspects, the control unit (225) extends the target period when the first determination unit (222) has made, even after the target period has passed, a decision similar to a decision made by the second determination unit (224) during the target period.

This aspect (a second method which may be used in combination with the first method) contributes to improving the accuracy of decision by extending the target period, if the first determination unit (222) continues to make similar decisions even after the second determination unit (224) has made a decision with respect to the target period.

In an area determination system (10) according to a sixth aspect, which may be implemented in conjunction with the fifth aspect, the control unit (225) postpones an end of the target period for a predetermined time (ΔT) when the first determination unit (222) decides, within the predetermined time (ΔT) since the second determination unit (224) has decided that the mobile device (40) be present in the target area (A10) during the target period, that the mobile device (40) be present in the target area (A10).

This aspect contributes, if the first determination unit (222) continues to make decisions of presence even after the second determination unit (224) has made a decision of presence with respect to the target period, to improving the accuracy of decision by extending the target period.

In an area determination system (10) according to a seventh aspect, which may be implemented in conjunction with the fifth or sixth aspect, the control unit (225) postpones an end of the target period for a predetermined time (ΔT) when the first determination unit (222) decides, within the predetermined time (ΔT) since the second determination unit (224) has decided that the mobile device (40) be absent from the target area (A10) during the target period, that the mobile device (40) be absent from the target area (A10).

This aspect contributes, if the first determination unit (222) continues to make decisions of absence even after the second determination unit (224) has made a decision of absence with respect to the target period, to improving the accuracy of decision by extending the target period.

In an area determination system (10) according to an eighth aspect, which may be implemented in conjunction with any one of the first to fourth aspects, the control unit (225) adopts, in a next target period following the target period, a weighted value, obtained by adding a weight to a value in the target period, with respect to at least one of the predetermined length (T) or the predetermined number of times (N) depending on the decision made by the second determination unit (224) during the target period.

This aspect (i.e., a third method which may be adopted in combination with the first method) contributes to improving the accuracy of decision by adding a weight to at least one of the predetermined length (T) or the predetermined period (T) in the next target period depending on the decision made during the target period.

In an area determination system (10) according to a ninth aspect, which may be implemented in conjunction with the eighth aspect, when the second determination unit (224) has decided that the mobile device (40) be absent from the target area (A 10) during the target period. the control unit (adopts, in the next target period, at least one of a first weighted value (α1×T) or a second weighted value (β1×N). The first weighted value (α1×T) is a weighted value calculated by multiplying a value (T) of the predetermined length (T) in the target period by a weighting coefficient (α1, where α1<1) less than 1. The second weighted value (β1×N) is a weighted value calculated by multiplying a value of the predetermined number of times (N) in the target period by a weighting coefficient (β1, where β1>1) greater than 1.

This aspect contributes to improving the accuracy of decision by adopting, in response to a decision of absence made with respect to the target period, at least one of a first weighted value (α1×T, where α1<1) or a second weighted value (β1×N, where β1>1) in the next target period.

In an area determination system (10) according to a tenth aspect, which may be implemented in conjunction with the ninth aspect, when the second determination unit (224) has decided that the mobile device (40) be absent from the target area (A10) during the target period and the next target period overlaps with a reserved period of the target area (A10), the control unit (225) adopts the first weighted value (α1×T) with respect to the predetermined length (T) in the next target period.

This aspect contributes to improving the accuracy of decision by adopting the first weighted value (α1×T) in the next target period when a decision of absence is made with respect to the target period and the next target period overlaps with the reserved period.

In an area determination system (10) according to an eleventh aspect, which may be implemented in conjunction with the ninth or tenth aspect, when the second determination unit (224) has decided that the mobile device (40) be present in the target area (A10) during the target period, the control unit (225) adopts, in the next target period, at least one of a third weighted value (α2×T) or a fourth weighted value (β2×N). The third weighted value (α2×T) is a weighted value calculated by multiplying a value (T) of the predetermined length (T) in the target period by a weighting coefficient (α2, where α2>1) greater than 1. The fourth weighted value (β2×N) is a weighted value calculated by multiplying a value of the predetermined number of times (N) in the target period by a weighting coefficient (β2, where β2>1) less than 1.

This aspect contributes to improving the accuracy of decision by adopting, when a decision of presence is made with respect to the target period, at least one of the third weighted value (α2×T) or the fourth weighted value (β2×N) in the next target period.

In an area determination system (10) according to a twelfth aspect, which may be implemented in conjunction with the eleventh aspect, when the second determination unit (224) has decided that the mobile device (40) be present in the target area (A10) during the target period and the next target period overlaps with a reserved period of the target area (A10), the control unit (225) adopts the third weighted value (α2×T) with respect to the predetermined length (T) in the next target period.

This aspect contributes to improving the accuracy of decision by adopting, when a decision of presence is made with respect to the target period and the next target period overlaps with the reserved period, the third weighted value (α1×T) in the next target period.

An area determination method according to a thirteenth aspect includes a detection step (S4), a first determination step (S5), an obtaining step (S7), a second determination step (S10, S13, and S14), and a control step (S11 and S12, S15 and S18, and S13a and S14b). The detection step (S4) includes detecting, based on a received signal strength of a wireless signal (W10) being transmitted and received to/from a mobile device (40), location of the mobile device (40) to acquire mobile device location information indicating a result of detection. The first determination step (S5) includes determining, based on the mobile device location information, whether the mobile device (40) is present in a target area (A10). The obtaining step (S7) includes obtaining a number of times (n) of decisions of presence. The number of times (n) of decisions of presence indicates a numerical number of times that a decision has been made in the first determination step (S5) that the mobile device (40) be present in the target area (A10) during a target period having a predetermined length (T). The second determination step (S10, S13, and S14) includes deciding, when the number of times (n) of decisions of presence is equal to or greater than a predetermined number of times (N), that the mobile device (40) be present in the target area (A10) during the target period and deciding, when the number of times (n) of decisions of presence is less than the predetermined number of times (N), that the mobile device (40) be absent from the target area (A10) during the target period. The control step (S11 and S12, S15 and S18, and S13a and S14b) includes controlling, using at least one selected from the group consisting of a time lag between multiple decisions of presence during the target period, the predetermined length (T), and the predetermined number of times (N), either determination processing in the second determination step (S10, S13, and S14) or decisions made in the second determination step (S10, S13, and S14).

This aspect contributes to more accurately determining whether the mobile device (40) is present in, or absent from, the target area (A10).

A program according to a fourteenth aspect is designed to cause one or more processors to perform the area determination method according to the thirteenth aspect.

This aspect contributes to more accurately determining whether the mobile device (40) is present in, or absent from, the target area (A10).

### Reference Signs List

10 Area Determination System
20 Server
21 Acceptance Unit
22 Processing Unit
221 Detection Unit
222 First Determination Unit
223 Obtaining Unit
224 Second Determination Unit
225 Control Unit
23 Output Unit
30 Terminal
40 Mobile Device
T Predetermined Length
N Predetermined Number of Times
Δt Maximum Difference
Δt0 Threshold Value
ΔT Predetermined Time
W10 Wireless Signal
A10-A16 Target Area

1. An area determination system comprising:
a detection unit configured to detect, based on a received signal strength of a wireless signal being transmitted and received to/from a mobile device, location of the mobile device to acquire mobile device location information indicating a result of detection;
a first determination unit configured to determine, based on the mobile device location information, whether the mobile device is present in a target area;
an obtaining unit configured to obtain a number of times of decisions of presence indicating a numerical number of times that the first determination unit has decided that the mobile device be present in the target area during a target period having a predetermined length;
a second determination unit configured to decide, when the number of times of decisions of presence is equal to or greater than a predetermined number of times, that the mobile device be present in the target area during the target period and decide, when the number of times of decisions of presence is less than the predetermined number of times, that the mobile device be absent from the target area during the target period; and
a control unit configured to control, using at least one selected from the group consisting of a time lag between multiple decisions of presence during the target period, the predetermined length, and the predetermined number of times, either determination processing by the second determination unit or decisions made by the second determination unit.

2. The area determination system of claim 1, wherein
the mobile device includes one member selected from the group consisting of a transmitter configured to transmit the wireless signal either at regular intervals or at irregular intervals and a receiver configured to receive the wireless signal, and
the detection unit is configured to detect, via a terminal including the other member selected from the group consisting of the transmitter and the receiver, the location of the mobile device based on a received signal strength of the wireless signal at the receiver.

3. The area determination system of claim 1, wherein
the detection unit is configured to acquire timestamp information indicating a point in time when the location has been detected and accumulate the timestamp information in association with the mobile device location information, and
the first determination unit is configured to accumulate, in association with the timestamp information, either presence information indicating a decision of presence or absence information indicating a decision of absence.

4. The area determination system of claim 3, wherein
the control unit is configured to, when the number of times of decisions of presence is equal to or greater than the predetermined number of times, calculate a difference between two pieces of timestamp information corresponding to two pieces of presence information acquired during the target period which are adjacent to each other and obtain a maximum difference that is a maximum value of one or more differences thus calculated, and
the control unit is also configured to, even when the number of times of decisions of presence is equal to or greater than the predetermined number of times but the maximum difference is greater than a threshold value, make the second determination unit decide that the mobile device be absent from the target area during the target period.

5. The area determination system of claim 1, wherein
the control unit is configured to extend the target period when the first determination unit has made, even after the target period has passed, a decision similar to a decision made by the second determination unit in the target period.

6. The area determination system of claim 5, wherein
the control unit is configured to postpone an end of the target period for a predetermined time when the first determination unit decides, within the predetermined time since the second determination unit has decided that the mobile device be present in the target area during the target period, that the mobile device be present in the target area.

7. The area determination system of claim 5, wherein
the control unit is configured to postpone an end of the target period for a predetermined time when the first determination unit decides, within the predetermined time since the second determination unit has decided that the mobile device be absent from the target area during the target period, that the mobile device be absent from the target area.

8. The area determination system of claim 1, wherein
the control unit is configured to adopt, in a next target period following the target period, a weighted value, obtained by adding a weight to a value in the target period, with respect to at least one of the predetermined length or the predetermined number of times depending on the decision made by the second determination unit during the target period.

9. The area determination system of claim 8, wherein
the control unit is configured to, when the second determination unit has decided that the mobile device be absent from the target area during the target period, adopt, in the next target period, at least one of a first weighted value with respect to the predetermined length or a second weighted value with respect to the predetermined number of times, the first weighted value being calculated by multiplying a value of the predetermined length in the target period by a weighting coefficient less than 1, the second weighted value being calculated by multiplying a value of the predetermined number of times in the target period by a weighting coefficient greater than 1.

10. The area determination system of claim 9, wherein
the control unit is configured to, when the second determination unit has decided that the mobile device be absent from the target area during the target period and the next target period overlaps with a reserved period of the target area, adopt the first weighted value with respect to the predetermined length in the next target period.

11. The area determination system of claim 9, wherein
the control unit is configured to, when the second determination unit has decided that the mobile device be present in the target area during the target period, adopt, in the next target period, at least one of a third weighted value with respect to the predetermined length or a fourth weighted value with respect to the predetermined number of times, the third weighted value being calculated by multiplying a value of the predetermined length in the target period by a weighting coefficient greater than 1, the fourth weighted value being calculated by multiplying a value of the predetermined number of times in the target period by a weighting coefficient less than 1.

12. The area determination system of claim 11, wherein
the control unit is configured to, when the second determination unit has decided that the mobile device be present in the target area during the target period and the next target period overlaps with a reserved period of the target area, adopt the third weighted value with respect to the predetermined length in the next target period.

13. An area determination method comprising:
a detection step including detecting, based on a received signal strength of a wireless signal being transmitted and received to/from a mobile device, location of the mobile device to acquire mobile device location information indicating a result of detection;
a first determination step including determining, based on the mobile device location information, whether the mobile device is present in a target area;
an obtaining step including obtaining a number of times of decisions of presence indicating a numerical number of times that a decision has been made in the first determination step that the mobile device be present in the target area during a target period having a predetermined length;
a second determination step including deciding, when the number of times of decisions of presence is equal to or greater than a predetermined number of times, that the mobile device be present in the target area during the target period and deciding, when the number of times of decisions of presence is less than the predetermined number of times, that the mobile device be absent from the target area during the target period; and
a control step including controlling, using at least one selected from the group consisting of a time lag between multiple decisions of presence during the target period, the predetermined length, and the predetermined number of times, either determination processing in the second determination step or decisions made in the second determination step.

14. A non-transitory storage medium storing a program designed to cause one or more processors to perform the area determination method of claim 13.
